(19) United States
(12) Patent Application Publication
(10) Pub. No.: US 2017/0159459 A1
(43) Pub. Date: Jun. 8, 2017

(54) PART COATED WITH A SURFACE COATING AND ASSOCIATED METHODS

(71) Applicant: SAFRAN CERAMICS, LE HAILLAN (FR)

(72) Inventors: Emilie COURCOT, Le Taillan (FR); Eric PHILIPPE, Merignac (FR); Eric BOUILLON, Le Haillan (FR); Sébastien JIMENEZ, Bordeaux (FR)

(21) Appl. No.: 15/323,668

(22) PCT Filed: Jun. 24, 2015
(86) PCT No.: PCT/EP2015/064203

§ 371 Date: Jan. 3, 2017

(30) Foreign Application Priority Data
Jul. 3, 2014 (FR) 1456390

(51) Int. Cl. F01D 5/28; C04B 35/628; C23C 26/02; C04B 41/00; C04B 41/51; C04B 41/88; C04B 35/80; C04B 35/657

(52) U.S. Cl. CPC F01D 5/284; C04B 35/806; C04B 35/62868; C04B 35/657; C04B 41/009; C04B 41/5144; C04B 41/88; C23C 26/02; F01D 5/288; C04B 2235/5244; C04B 2235/524; C04B 2235/3826; C04B 2235/616; F05D 2300/611; F05D 2300/6033

(57) ABSTRACT

A part made of composite material includes fiber reinforcement densified by a ceramic matrix. The part presents an outside surface and is coated over at least a portion of its outside surface by a surface coating in solid form including an alloy of silicon and nickel presenting a content by weight of silicon lying in the range 29% to 45%, or an alloy of silicon and cobalt.

### BACKGROUND OF THE INVENTION

The invention relates to parts made of ceramic matrix composite (CMC) material including a surface coating, to the use of such parts within turbine engines, and also to methods of fabricating such parts.

CMC materials are suitable for making parts that are to be exposed in service to high temperatures, and they present the advantage of retaining good mechanical properties at high temperature.

It is known to treat the surfaces of CMC materials as a function of the applications for which they are intended. By way of example, the following coatings can be made on the surface of a CMC:
a smoothing coating for the airfoil zone of a turbine blade so as to improve its aerodynamic nature;
an environmental barrier for protecting silicon carbide (SiC) from the phenomenon of wet corrosion at high temperature; or
a coating for limiting the phenomena of wear and fretting at interfaces.

At present, functional coatings are made on a composite material at a final stage of its preparation.

There is therefore complete decoupling between fabricating the CMC and forming its coating. Coatings based on oxides that are used for improving corrosion resistance and for smoothing the surface can be prepared by plasma spraying or flash sintering. Carbide type coatings may be made by powder deposition technologies (e.g. painting, dip-coating, injection molding, overmolding) followed by consolidation by a gaseous technique.

Present methods of fabricating coated CMC parts present two main drawbacks.

Firstly, those methods can include a large number of steps and thus be relatively complex and expensive. Furthermore, the attachment of the resulting coating on the composite material might not be entirely satisfactory because of the decoupling that exists between fabricating the CMC and forming its coating.

Furthermore, another problem that needs to be taken into consideration for CMC parts concerns the chemical interactions to which such parts can be subjected by the support on which they are mounted while they are in use. Such interactions can be problematic insofar as they can lead to damage to CMC parts and/or to metal parts.

There thus exists a need to obtain new CMC parts presenting limited interactions with the supports on which they are to be mounted while they are in use.

There also exists a need to obtain new CMC parts that present increased ability to withstand fretting phenomena.

There also exists a need to obtain methods that are simpler and less expensive for preparing CMC parts that are covered in a coating.

### OBJECT AND SUMMARY OF THE INVENTION

To this end, in a first aspect, the invention provides a part made of composite material comprising fiber reinforcement densified by a ceramic matrix, the part presenting an outside surface and being characterized in that it is coated over at least a portion of its outside surface by a surface coating in solid form comprising, in particular consisting of, an alloy of silicon and nickel presenting a content by weight of silicon lying in the range 29% to 45%, or an alloy of silicon and cobalt.

Implementing such alloys within the coating serves advantageously to limit interactions, in particular chemical reactions, between the part and the material constituting the support on which the part is to be mounted while it is in use.

Thus, the inventors have found that the presence within the surface coating of an alloy as described above including silicon together with a metal constituting a major portion of the support on which the part is to be mounted (nickel or cobalt) serves advantageously to limit interactions between the part and the support. Thus, the part of the invention advantageously presents limited interactions with a superalloy based on nickel and/or cobalt constituting the fastener support, with this being because the silicon is saturated by the nickel or the cobalt present within the coating.

The term “surface coating” should be understood as a coating having the majority of its weight present on the outside surface of the part. In other words, at least 50%, preferably at least 60%, preferably at least 70%, preferably at least 80%, preferably at least 90%, preferably at least 95%, preferably substantially 100% of the weight of the surface coating is present on the outside surface of the part (and thus outside the part).

It is also possible for the surface coating to penetrate a little into the part, e.g. in order to fasten the coating to the part. Nevertheless, the surface coating preferably does not penetrate substantially into the part.

The surface coating is fastened to the outside surface of the part and may penetrate into the pores of the outside surface of the part.

The alloy of silicon and nickel or of silicon and cobalt may be in contact with the ceramic matrix.

Furthermore, the surface coating preferably does not densify the fiber reinforcement. The surface coating may reproduce the shape of the part that it coats. Thus, the surface of the surface coating that is situated remote from the part may have the same shape as the outside surface of the part.

In an embodiment, the surface coating may comprise a phase of NiSi₂ and/or a phase of NiSi. In particular, the surface coating may comprise:
a phase of NiSi₂ and optionally a phase of Si; and/or
a phase of NiSi and optionally a phase of Si.

In an embodiment, the surface coating may comprise a phase of CoSi₂ and optionally a phase of Si.

Preferably, the alloy of silicon and nickel may present a content by weight of silicon lying in the range 40% to 45%.

Preferably, the alloy of silicon and cobalt may present a content by weight of silicon lying in the range 34% to 90%, e.g. in the range 40% to 90%, e.g. in the range 42% to 70%, e.g. in the range 45% to 60%.

The alloy of silicon and nickel or of silicon and cobalt may be present at a content by weight greater than or equal to 5%, preferably greater than or equal to 50%, relative to the weight of the surface coating.

The thickness of the surface coating over all or part of the outside surface of the coated part may lie in the range 20 micrometers (μm) to 1000 μm, and preferably in the range 50 μm to 300 μm.

In particular, and by way of example, when the part constitutes an aeroengine blade, the thickness of the surface coating may be less than or equal to 300 μm in the blade root zone and/or less than equal to 100 μm in the airfoil zone.

The thickness of the surface coating may vary on moving along the outside surface of the part.

Such thickness variation serves advantageously to have a part with its coating presenting different functions depending on the zone under consideration.

In a variant, the thickness of the surface coating may be substantially constant on moving along the outside surface of the part.

The surface coating may further include fillers and/or a ceramic material.

The fillers present within the surface coating may be selected from: SiC, Si₃N₄, or BN, and mixtures thereof.

The ceramic material present within the surface coating may be selected from ceramic materials obtained by pyrolyzing preceramic resins, where the preceramic resins may for example be selected from: polycarbosilanes, polysilazanes, polyborosilanes, and mixtures thereof.

In an embodiment, the surface coating may present substantially the same composition on moving along the outside surface of the part.

In a variant, the composition of the surface coating may vary on moving along the outside surface of the part.

Such a variation in composition advantageously makes it possible to have a part with a coating that presents different functions depending on the zone under consideration.

The fibers of the fiber reinforcement are advantageously coated in an interphase layer.

The use of an interphase is advantageous in so far as it makes it possible to increase the mechanical strength of the fibers constituting the fiber reinforcement, in particular by enabling any cracks in the matrix to be deflected so that they do not affect the integrity of the fibers.

The interface layer may comprise, and in particular may consist of, pyrocarbon (PyC), boron doped pyrocarbon, or BN. The interphase layer may optionally be multi-sequenced, e.g. comprising a repetition of [PyC/carbide], [BC/carbide], or [BN/carbide] sequences.

The fibers of the fiber reinforcement are advantageously coated in a barrier layer, which may for example be in the form of a self-healing carbide matrix.

The use of such a barrier layer advantageously makes it possible to protect the fibers against oxidation and to generate a network of cracks that is remote from the fiber reinforcement.

The part may constitute an aeroengine blade comprising at least a blade root and an airfoil, and it may be such that the surface coating covers at least the blade root. In a variant, the part may constitute a turbine ring sector including one or more attachment portions for attachment to a metal ring support structure and it may be such that the surface coating covers at least said attachment portion(s).

The present invention also provides a turbine engine rotor wheel comprising:
a wheel disk having a blade fastener portion, said fastener portion comprising an alloy including nickel and/or cobalt; and
a blade as defined above, fastened to the wheel disk, the blade root being mounted in the blade fastener portion.

The present invention also provides a method of fabricating a part as defined above, the method comprising the following steps:

a) infiltrating a fiber preform having a first set of fillers, e.g. a first set of reactive fillers, with an infiltration composition in the molten state, the infiltration composition comprising silicon and having a first melting temperature, so as to obtain, after putting the infiltration composition into contact with all or part of the fillers of the first set of fillers, a part made of composite material having fiber reinforcement densified by a ceramic matrix; and

b) applying on at least a portion of the outside surface of the part made of composite material an alloy in the molten state of silicon and nickel or of silicon and cobalt, the alloy of silicon and nickel or of silicon and cobalt having a second melting temperature lower than the first melting temperature in order to obtain a surface coating in solid form over at least a portion of the outside surface of the composite material part.

The use of such a method advantageously makes it possible to simplify preparing a CMC part covered in a surface coating.

The fact of using an alloy of silicon and nickel or of silicon and cobalt having a melting temperature lower than the melting temperature of the infiltration composition advantageously makes it possible, while forming the surface coating, to avoid melting once more the infiltration composition that has not reacted.

The method may also include, after step a) and before step b), a step c) of depositing on the outside surface of the composite material part a second set of fillers and/or a preceramic resin, and the method may be such that the alloy in the molten state of silicon and nickel or of silicon and cobalt then infiltrates during step b) within the second set of fillers and/or preceramic resin in order to form the surface coating.

The fillers of the second set of fillers may be reactive or non-reactive. By way of example, non-reactive fillers of the second set of fillers may be selected from: SiC, Si₃N₄, or BN, and mixtures thereof. By way of example, reactive fillers of the second set of fillers may be selected from: C, B₄C, SiB₆, and mixtures thereof.

The alloy in the molten state of silicon and nickel or of silicon and cobalt may react chemically with the reactive fillers deposited during step c) while coming into contact therewith. In a variant, once it has solidified, the alloy of silicon and nickel or of silicon and cobalt may participate in providing bonding for the fillers deposited during step c).

The method of the invention may thus make use of two melt-infiltration steps, the first for forming the ceramic matrix and the second for forming the surface coating.

The fact of using the same type of method twice over contributes advantageously to simplifying preparation of the coated part.

The deposition performed during step c) may advantageously be of thickness and/or composition that vary on moving along the outside surface of the part, e.g. in different functional zones of the part.

Such a deposit advantageously makes it possible to obtain a coating presenting different functions depending on the position on the outside surface of the part.

The present invention also provides a method of fabricating a part as defined above, the method including a step:
of forming a surface coating in solid form on the outside surface of a part made of composite material comprising fiber reinforcement densified by a ceramic matrix, the surface coating comprising an alloy of silicon and nickel or of silicon and cobalt.

The forming of the surface coating may comprise a step of putting an alloy in the molten state of silicon and nickel or of silicon and cobalt into contact with fillers, for example reactive fillers, or in a variant non-reactive fillers, and/or with a preceramic resin.

By way of example, the non-reactive fillers may be selected from: SiC, Si₃N₄, or BN, and mixtures thereof. By way of example, the reactive fillers may be selected from: C, B₄C, SiB₆, and mixtures thereof.

The alloy in the molten state of silicon and nickel or of silicon and cobalt may react chemically with the reactive fillers on coming into contact therewith. In a variant, once solidified, the alloy of silicon and nickel or of silicon and cobalt may participate in providing bonding for the fillers.

Prior to melting the alloy of silicon and nickel or of silicon and cobalt, the part may be covered on its outside surface by a coating precursor layer including firstly the alloy of silicon and nickel or of silicon and cobalt, and secondly the fillers, e.g. reactive fillers or in a variant non-reactive fillers, and/or the preceramic resin.

### BRIEF DESCRIPTION OF THE DRAWINGS

Other characteristics and advantages of the invention appear from the following description of particular embodiments of the invention given as non-limiting examples and with reference to the accompanying drawings, in which:

FIG. 1 is a diagrammatic and fragmentary section of a part of the invention;

FIG. 2 is a flow chart of an example method of preparing a part of the invention;

FIG. 3 is a more detailed flow chart of an example method of preparing a part of the invention;

FIG. 4 is a flow chart of a variant method of preparing a part of the invention;

FIG. 5 is a perspective view of a part of the invention consisting in a turbine engine blade; and

FIG. 6 is a perspective view of a turbine engine rotor wheel.

### DETAILED DESCRIPTION OF EMBODIMENTS

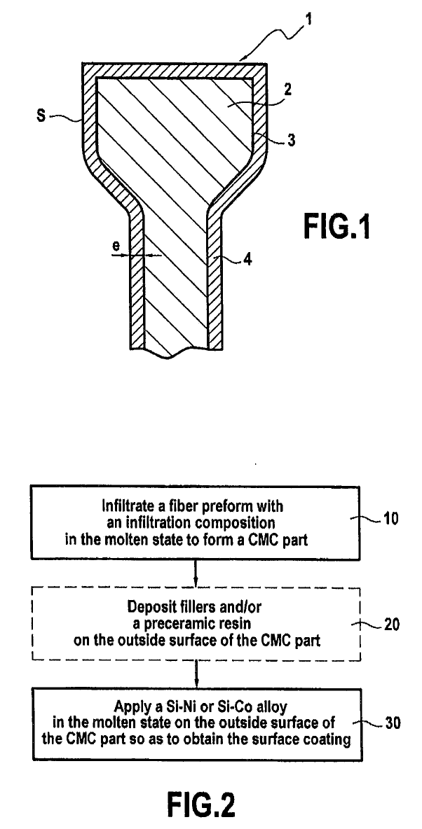

FIG. 1 is a section of a part 1 made of composite material comprising fiber reinforcement (not shown) densified by a ceramic matrix 2. On its outside surface 3, the part 1 has a surface coating 4 in solid form comprising, and in particular constituted by, an alloy of silicon and nickel or of silicon and cobalt.

In addition, the surface coating 4 may include fillers and/or a ceramic material.

As shown, the surface coating 4 does not penetrate within the matrix 2. Specifically, the surface coating 4 in the example shown remains entirely on the outside surface 3 of the part 1. It would not go beyond the ambit of the invention if the surface coating were to penetrate within the matrix so long as the majority of the weight of the coating remains on the outside surface of the part (i.e. outside it).

As shown, the thickness e of the surface coating 4 may be substantially constant when moving along the outside surface 3 of the part. In a variant that is not shown, the thickness e of the surface coating could vary when moving along the outside surface of the part.

As shown, the surface coating 4 may reproduce the shape of the part 1. In the example shown, the surface S of the surface coating that is situated remote from the part 1 presents the same shape as the outside surface 3 of the part 1.

There follows a more detailed description of some elements relating to the fabrication of composite materials comprising fiber reinforcement densified by a ceramic matrix and suitable for use in the context of the present invention.

The fiber preform that is to form the fiber reinforcement of the part of the invention may be obtained by multilayer weaving between a plurality of layers of warp yarns and a plurality of layers of weft yarns. The multilayer weaving may be performed in particular by using an interlock weave, i.e. a weave in which each layer of weft yarns interlinks a plurality of layers of warp yarns, with all of the yarns in any one of weft column having the same movement in the weave plane.

Other types of multilayer weaving could naturally be used.

When the fiber preform is made by weaving, the weaving may be performed with warp yarns extending in the longitudinal direction of the preform, it being understood that it is also possible for weaving to be performed with weft yarns in this direction.

In an embodiment, the yarns used may be yarns made of silicon carbide (SiC) supplied under the name “Nicalon”, “Hi-Nicalon”, or “Hi-Nicalon-S” by the Japanese supplier Nippon Carbon, or “Tyranno SA3” by the supplier UBE and having a count (number of filaments) of 0.5 K (500 filaments).

Various ways of performing multilayer weaving are described in particular in Document WO 2006/136755.

The fiber reinforcement of the part of the invention may also be made from a fiber preform obtained by assembling together two fiber textures. Under such circumstances, the two fiber textures may be bonded together, e.g. by stitching or needling. Each of the two fiber textures may in particular be obtained from a layer or a stack of a plurality of layers of:
a unidimensional (UD) fabric;
a two-dimensional (2D) fabric;
a braid;
a knit;
a felt; or
a unidirectional (UD) sheet of multidirectional yarns (nD) yarns or tows or sheets obtained by superposing a plurality of UD sheets in different directions and bonding together the UD sheets, e.g. by stitching, by a chemical bonding agent, or by needling.

With a stack of a plurality of layers, the layers may for example be bonded together by stitching, by implanting yarns or rigid elements, or by needling.

As described above, a fiber preform for forming the fiber reinforcement of a part of the invention may be obtained by multilayer weaving, or by stacking fiber structures. For turbine engine blades that are for use at high temperature, and in particular in a corrosive environment (in particular a wet environment), it is possible advantageously to perform the weaving using yarns made of ceramic fibers, and in particular silicon carbide (SiC) fibers. For parts having shorter durations of use, it is also possible to use carbon fibers.

The fiber preform that is to form the fiber reinforcement of the part of the invention is densified by filling in the pores of the preform throughout some or all of its volume with the material that constitutes the matrix. By way of example, this densification may be performed in known manner using the liquid method or the gaseous method (CVI), or indeed by using both methods in succession.

The liquid method consists in impregnating the preform with a liquid composition containing a precursor of the matrix material. The precursor is usually in the form of a polymer, such as a resin, possibly diluted in a solvent. The preform is placed in a mold that can be closed in sealed manner and that has a cavity with the shape of the final molded part. Thereafter, the mold is closed and the liquid matrix precursor (e.g. a resin) is injected throughout the cavity in order to impregnate the entire fiber portion of the preform.

The precursor is transformed into a matrix by heat treatment, generally by heating the mold, after eliminating the solvent if any and after curing the polymer, with the preform continuing to be held in the mold having a shape corresponding to the shape of the part that is to be made.

When forming a ceramic matrix, the heat treatment includes a step of pyrolyzing the precursor in order to form the ceramic matrix. By way of example, liquid ceramic precursors, in particular for SiC, may be resins of the polycarbosilane (PCS) or the polytitanocarbosilane (PTCS) or the polysilazane (PSZ) type. A plurality of consecutive cycles running from impregnation to heat treatment may be performed in order to achieve the desired degree of densification.

The fiber preform may also be densified in known manner by a gaseous technique using chemical vapor infiltration (CVI) of the matrix. The fiber preform corresponding to the structure that is to be made is placed in an oven into which a reaction gas phase is admitted. The pressure and the temperature that exist in the oven and the composition of the gas phase are selected so as to enable the gas phase to diffuse within the pores of the preform so as to form the matrix therein by depositing a solid material in the core of the material in contact with the fibers, which solid material is the result of a component of the gas phase decomposing or of a reaction between a plurality of components.

An SiC matrix may be obtained with methyltricholosilane (MTS) that gives SiC by decomposition of the MTS.

Densification that combines a liquid technique and a gaseous technique may also be used in order to facilitate working, limit costs, and limit fabrication cycles, while still obtaining characteristics that are satisfactory for the intended use.

The part may include carbon and/or ceramic fiber reinforcement densified by a ceramic matrix, e.g. selected from the following matrices: SiC/Si, Si₃N₄/SiC/Si, SiB, or SiMo.

As described in detail below, it is possible to fabricate the part of the invention by performing other methods for densifying the fiber reinforcement with a ceramic matrix, such as in particular melt-infiltration methods.

With reference to FIGS. 2 to 4, there follows a description of methods of preparing parts of the invention that make use of a step of infiltrating a fiber preform in order to form the ceramic matrix.

FIG. 2 shows a flow chart giving the steps of a first implementation of a method of the invention.

A fiber preform including reactive fillers, e.g. selected from SiC, Si₃N₄, C, B, and mixtures thereof, is initially infiltrated by an infiltration composition in the molten state that includes silicon (step 10). After the infiltration composition and the reactive fillers have reacted, a composite material part having a ceramic matrix is obtained. During the reaction between the infiltration composition and the reactive fillers, the reactive fillers may be consumed substantially completely. In a variant, the reactive fillers are consumed in part only during this reaction.

The infiltration composition may be constituted by molten silicon, or in a variant it may be in the form of a molten alloy of silicon and one or more other constituents. The constituent(s) present within the silicon alloy may be selected from B, Al, Mo, Ti, and mixtures thereof.

Before being infiltrated with the infiltration composition, the fibers of the fiber reinforcement may be coated in an interphase layer, e.g. of BN or silicon-doped BN, together with a carbide layer, e.g. of SiC and/or Si₃N₄, e.g. made using the gaseous technique.

The matrix may be obtained by a reaction between a molten alloy based on silicon and solid fillers, e.g. of the C, SiC, or Si₃N₄ type that may be introduced by means of a slurry, or that may be preimpregnated. The reaction may take place at a temperature that is higher than or equal to 1420° C. Given the high temperatures used, it may be advantageous for the fiber reinforcement to be constituted by temperature stable fibers, e.g. of the Hi-Nicalon or indeed Hi-Nicalon-S type.

Once the ceramic matrix has been obtained, it is then possible to proceed with an optional step of depositing fillers and/or a preceramic resin on the outside surface of the part (step 20).

The step 30 that is performed subsequently consists in applying on the outside surface of the CMC part an alloy in the molten state of silicon and of nickel or of silicon and of cobalt, the alloy having a melting temperature that is lower than the melting temperature of the infiltration composition that was used for forming the ceramic matrix for densifying the fiber reinforcement.

When fillers and/or a preceramic resin are deposited on the outside surface of the part (i.e. when a step 20 is performed), the alloy of silicon and nickel or of silicon and cobalt in the molten state can infiltrate within the fillers and/or the resin during step 30.

Under such circumstances, two successive molten infiltration steps are thus performed, the first for making the ceramic matrix (step 10) followed by the second for making the surface coating (step 30).

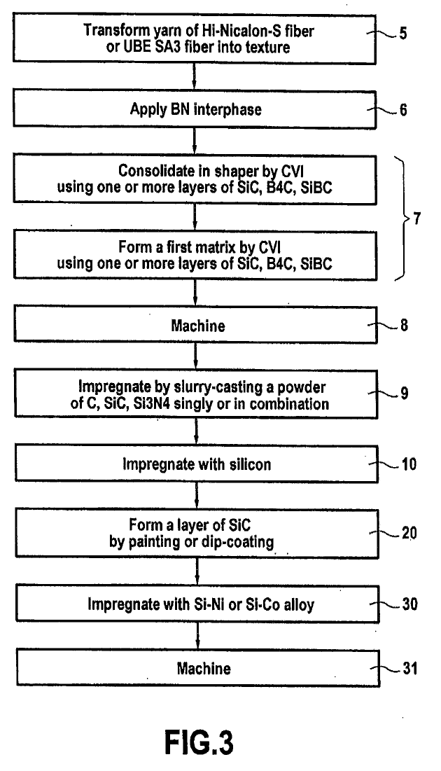

FIG. 3 is a more detailed flow chart of a method of fabricating a part of the invention in the variant shown in FIG. 2. This method may comprise the following steps:
preparing a fiber preform, e.g. based on Hi-Nicalon S fibers (step 5), e.g. by weaving and preforming using the liquid and/or gaseous technique(s), the fibers of the fiber preform being coated in an interphase layer (step 6), e.g. of pyrocarbon (PyC) or of BN, and in a coating making it possible i) to avoid a reaction between the infiltration composition and either the fibers or the interphase, and ii) to consolidate the fiber preform (step 7), the coating being for example made of a carbide, e.g. SiC, B₄C, and/or SiBC, and possibly including a self-healing matrix, which coating may be deposited by CVI;
machining the fiber preform (step 8, this step is optional in the implementation under consideration);
introducing within the fiber preform a first set of fillers, e.g. reactive fillers, by a slurry cast technique (step 9), the fillers being selected for example from SiC, Si₃N₄, C, B, and mixtures thereof, and the excess of fillers at the surface optionally being eliminated in full or in part at the end of the slurry cast;
infiltrating the fiber preform with the infiltration composition in the molten state (step 10; melt-infiltration method) in order to form the ceramic matrix, this infiltration optionally being preceded by a step of deoxidizing the fiber preform and the infiltration composition, infiltration serving for example to form a majority of silicon carbide with a minimum of residual silicon;
cleaning the composite, e.g. by a simple sanding or scalping operation (this step being optional in the implementation under consideration);
depositing a second set of fillers on the outside surface of the composite material part (step 20), e.g. fillers selected from: SiC, Si₃N₄, C, Mo₂C, B₄C, and mixtures thereof, and/or a preceramic resin, e.g. PCS, PSZ, or a phenolic resin, the deposition being performed by way of example by dip-coating, overmolding, or resin transfer molding (RTM), the deposit that is formed possibly being of varying thickness and/or varying composition on moving along the outside surface of the part, e.g. in different functional zones of the part, and in the example shown in FIG. 3, a deposit of SiC fillers is formed;
infiltrating the outside surface of the part with an alloy in the molten state of silicon and nickel or of silicon and cobalt, the alloy having a melting point lower than the melting point of the infiltration composition (step 30), this infiltration possibly being preceded by a step of deoxidizing the part and the alloy of silicon and nickel or of silicon and cobalt; and
finishing by machining (step 31; this step is optional in the implementation under consideration).

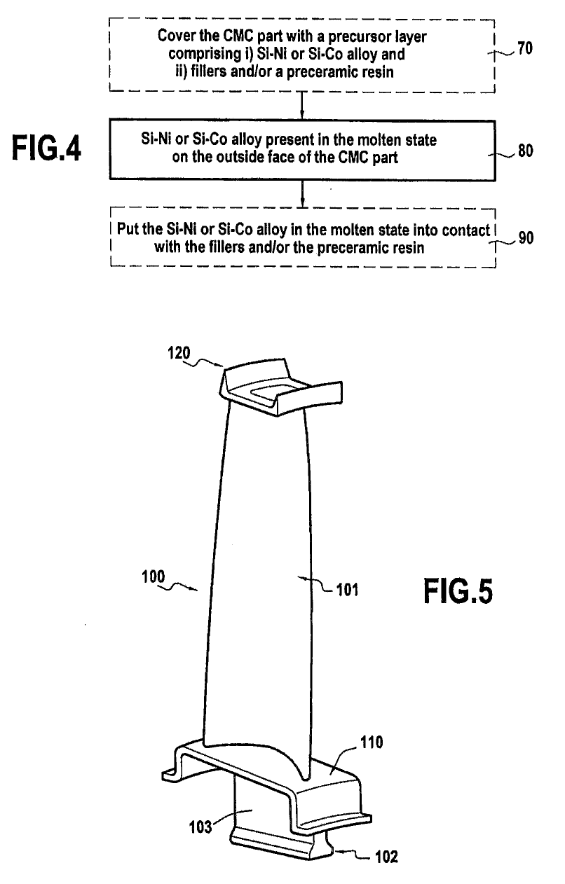

With reference to FIG. 4, there follows a description of a flow chart showing the steps of a variant of a method of preparing a part of the invention.

Unlike the methods described above in the detailed description, the method of FIG. 4 applies regardless of the method of preparing the composite material part (i.e. not only for parts made of composite material in which the ceramic matrix is obtained by melt-infiltration).

Firstly, the composite material part may be covered on its outside surface in a coating precursor layer comprising both the alloy of silicon and nickel or of silicon and cobalt together with fillers and/or a preceramic resin (optional step 70).

Theater, during step 80, the alloy in the molten state of silicon and nickel or of silicon and cobalt is present on the outside surface of the composite material part in order to form the surface coating. If optional step 70 has been performed, the alloy in the molten state of silicon and nickel or of silicon and cobalt is put into contact with the fillers and/or the resin (optional step 90).

There follows a more detailed example of a method of preparing a part of the invention using the variant shown in FIG. 4. The method may comprise the following steps:
forming on the outside surface of the composite material part a coating precursor layer including reactive fillers, e.g. selected from SiC, C, Si₃N₄, Mo₂C, B₄C, and mixtures thereof, and/or a preceramic resin, e.g. PCS, PSZ, or a phenolic resin, and/or an alloy of silicon and nickel or of silicon and cobalt, the coating precursor layer being formed by way of example after dip-coating, overmolding, or RTM, the coating precursor layer possibly being of varying thickness and/or varying composition on moving along the outside surface of the part, e.g. in different functional zones of the part, the coating precursor layer possibly also serving to smooth some or all of the surface of the outside zone of the part on which it is formed; and
infiltrating the alloy in the molten state of silicon and nickel or of silicon and cobalt on the outside surface of the composite material part in order to form the surface coating, this infiltration optionally being preceded by a step of deoxidizing the part and the alloy of silicon and nickel or of silicon and cobalt.

The invention is applicable to various types of turbine engine blade, and in particular to compressor blades and turbine blades for various gas turbine spools, e.g. a rotor wheel blade for a low pressure turbine, as shown in FIG. 5.

The blade 100 of FIG. 5 comprises in well-known manner an airfoil 101, a root 102 formed by a portion of greater thickness, e.g. having a bulb-shaped section, extended by a tang 103, an inner platform 110 situated between the tang 103 and the airfoil 101, and an outer platform 120 in the vicinity of the free end of the airfoil. The airfoil root 102 in the example shown is covered by a surface coating including an alloy of silicon and nickel or of silicon and cobalt (not shown). Naturally, it would not go beyond the ambit of the present invention for the blade root to be coated in a first surface coating comprising an alloy of silicon and nickel or of silicon and cobalt, with the airfoil being coated in a second surface coating that may be identical to or different from the first surface coating, e.g. serving to smooth the surface of said airfoil.

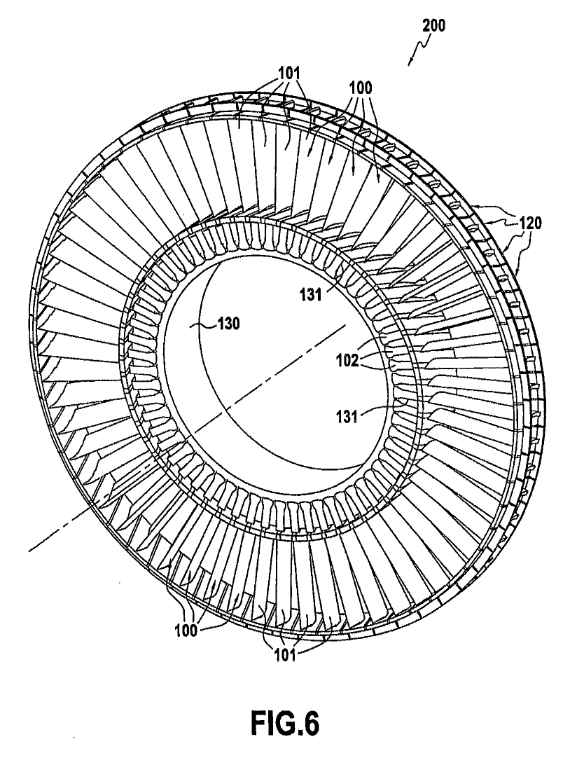

FIG. 6 shows an example turbine engine rotor wheel 200 of the invention.

The parts of the invention may be fastened to various types of turbine rotor, and in particular compressor rotors and turbine rotors of various gas turbine spools, e.g. a rotor wheel of a low pressure (LP) turbine, as shown in FIG. 6.

FIG. 6 shows a turbine engine rotor wheel 200 comprising a hub 130 on which there are mounted a plurality of blades 100 of the invention, each blade 100 comprising an airfoil 101 and a root 102 formed by a portion of greater thickness, e.g. of bulb-shaped section, that is engaged in a corresponding housing 131 arranged in the periphery of the hub 130. The walls of the housing 131 include nickel and/or cobalt.

The rotor wheel 200 also includes a plurality of blade outer platforms 120 mounted on each of the blades 100.

Parts of the invention may be fastened to low pressure or high pressure turbines of turbojets.

The parts of the invention may be fitted to turbojets, e.g. of the CMF 56, LEAP X, or M88 type. The parts of the invention may also be fitted to gas turbines.

### Example

A Guipex® texture was used to form the fiber reinforcement of a part of the invention. The texture was made of type S Hi-Nicalon® fibers sold by the supplier Nippon Carbon, it presented an interlock type weave, and it satisfied the following characteristics: warp yarn/weft yarn ratio=55/45, 10 warp yarns per centimeter (/cm) and 7.5 weft yarns/cm.

The texture was placed in a graphite shaper in order to obtain a fiber content of 40% by volume. The texture held in the shaper was then consolidated by a chemical vapor infiltration method so as to deposit on the fibers a layer of boron nitride (BN) and a layer of silicon carbide. The consolidated texture was extracted from the shaper and a new step of chemical vapor infiltration was performed in order to finish off densification of the texture and deposit silicon carbide in its pores. The consolidated and partially densified texture obtained in that way presented specific gravity of 2.0 and residual porosity of 30% by volume.

A slurry comprising an aqueous liquid medium filled to 20% by volume with a silicon carbide powder was injected into the partially densified consolidated texture by a submicron powder sucking method. The silicon carbide powder used presented a d50 grain size of 0.6 μm. The texture impregnated by the slurry was then placed in a stove and dried for three hours at 60° C. At the end of that step, the resulting texture presented a specific gravity of 2.3 and a porosity of 23% by volume.

The densification of the texture as obtained in that way was then finished off by infiltrating silicon in the molten state. Prior to infiltrating the texture with molten silicon, an anti-wetting composition based on boron nitride was applied to the faces of the texture in order to prevent molten silicon from overflowing on the outside of the part. The texture was then infiltrated with silicon in the molten state. Infiltration with molten silicon was performed under a pressure of 5 millibars (mbar) of argon with two consecutive temperature levels:
a first temperature of 1395° C. imposed for 1 hour (h), which temperature was reached after a ramp of 600° C. per hour (/h);
a second temperature of 1450° C. was imposed for 30 minutes (min), which temperature was reached after a ramp of 120° C./h.

During infiltration, the part was placed on a C/C drain that enabled to be fed with silicon.

At the end of infiltration, the anti-wetting composition was eliminated by cleaning in distilled water with ultrasound. At this stage, the part presented a specific gravity of 2.8 and porosity of about 2% by volume.

The outside surface of the resulting part was then coated in a coating composition comprising particles of silicon carbide having a grain size of 9 μm, of polycarbosilane, and a solvent (xylene). The polycarbosilane was then cured under argon by performing the following heat treatment:
rise to 90° C. in 1 h;
pause at 90° C. for 1 h;
rise to 220° C. in 100 min;
pause at 220° C. for 1 h;
rise to 350° C. in 1 h;
pause at 350° C. for 1 h; and
natural cooling.

Thereafter, the polycarbosilane was pyrolyzed under nitrogen at 900° C. for 1 h (rising at 100° C./h).

A silicon carbide phase obtained by pyrolyzing the PCS and a silicon carbide particulate phase were both present on the outside surface of the composite material part. An alloy in the molten state of silicon and nickel having a nickel atom content of 44% and a silicon atom content of 56% (corresponding to silicon representing about 38% by weight in the alloy) was then applied so as to infiltrate the silicon carbide phases present at the surface. Infiltration with the silicon and nickel alloy was performed under a secondary vacuum at two consecutive temperature levels:
a first temperature of 950° C. was imposed for 2 h, which temperature was reached after a ramp of 600° C./h; and
a second temperature of 1020° C. was imposed for 30 min, which temperature was reached after a ramp of 120° C./h.

The zone for densifying with the alloy was in contact with a carbon mat to enable the part to be fed with alloy. A solid coating having a thickness of 100 μm was obtained.

The term “comprising/containing a” should be understood as “comprising/containing at least one”.

The term “lying in the range . . . to . . . ” should be understood as including the limits.

1. A part made of composite material comprising fiber reinforcement densified by a ceramic matrix, the part presenting an outside surface, wherein the part is coated over at least a portion of the outside surface by a surface coating in solid form comprising an alloy of silicon and nickel presenting a content by weight of silicon lying in the range 29% to 45%, or an alloy of silicon and cobalt.

2. A part according to claim 1, wherein the surface coating comprises a phase of NiSi₂ and/or a phase of NiSi.

3. A part according to claim 1, wherein the surface coating comprises a phase of CoSi₂.

4. A part according to claim 1, wherein the alloy of silicon and nickel or of silicon and cobalt is present at a content by weight greater than or equal to 5% relative to a weight of the surface coating.

5. A part according to claim 1, wherein the surface coating further includes fillers and/or a ceramic material.

6. A part according to claim 1, wherein the alloy of silicon and cobalt presents a silicon content by weight lying in the range 34% to 90%.

7. A part according to claim 1, wherein the part constitutes an aeroengine blade comprising at least a blade root and an airfoil, and wherein the surface coating covers at least the blade root.

8. A turbine engine rotor wheel comprising:
a wheel disk having a blade fastener portion, said fastener portion comprising an alloy including nickel and/or cobalt; and
a part according to claim 7, fastened to the wheel disk, the blade root of the part being mounted in the blade fastener portion.

9. A method of fabricating a part according to claim 1, the method comprising:
a) infiltrating a fiber preform having a first set of fillers with an infiltration composition in the molten state, the infiltration composition comprising silicon and having a first melting temperature, so as to obtain, after putting the infiltration composition into contact with all or part of the fillers of the first set of fillers, a part made of composite material having fiber reinforcement densified by a ceramic matrix; and
b) applying on at least a portion of the outside surface of the part made of composite material an alloy in the molten state of silicon and nickel or of silicon and cobalt, the alloy of silicon and nickel or of silicon and cobalt having a second melting temperature lower than the first melting temperature in order to obtain a surface coating in solid form over at least a portion of the outside surface of the composite material part.

10. A method according to claim 9, further comprising, after step a) and before step b), a step c) of depositing on the outside surface of the composite material part a second set of fillers and/or a preceramic resin, and wherein the alloy in the molten state of silicon and nickel or of silicon and cobalt then infiltrates during step b) within the second set of fillers and/or preceramic resin in order to form the surface coating.

11. A method of fabricating a part according to claim 1, including a step:
of forming a surface coating in solid form on the outside surface of a part made of composite material comprising fiber reinforcement densified by a ceramic matrix, the surface coating comprising an alloy of silicon and nickel or of silicon and cobalt.

12. A method according to claim 11, wherein the forming of the surface coating comprises a step of putting an alloy in the molten state of silicon and nickel or of silicon and cobalt into contact with fillers and/or with a preceramic resin.

13. A method according to claim 12, wherein, prior to melting the alloy of silicon and nickel or of silicon and cobalt, the part is covered on the outside surface by a coating precursor layer including firstly the alloy of silicon and nickel or of silicon and cobalt, and secondly the fillers and/or the preceramic resin.
